(19) United States
(12) Patent Application Publication
(10) Pub. No.: US 2017/0355282 A1
(43) Pub. Date: Dec. 14, 2017

(54) SEAT POSITION DETECTION FOR SEAT ASSEMBLIES

(71) Applicants: Winsen C. Zouzal, Detroit, MI (US); Lear Corporation, Southfield, MI (US)

(72) Inventors: Winsen C. ZOUZAL, Detroit, MI (US); Gerald PATRICK, Shelby Township, MI (US)

(21) Appl. No.: 15/181,924

(22) Filed: Jun. 14, 2016

(51) Int. Cl. B60N 2/02; G01P 15/18; B60N 2/10; B60N 2/16; B60N 2/22; B60N 2/06; G01C 19/00

(52) U.S. Cl. CPC B60N 2/0244; B60N 2/06; G01P 15/18; G01C 19/00; B60N 2/16; B60N 2/22; B60N 2/10; B60N 2002/0272

(57) ABSTRACT

A seat assembly is provided with a seat bottom, a seat back, and a plurality of sensors operably connected to at least one of the seat bottom and the seat back to detect a seating condition of a seated occupant. A controller is in electrical communication with the plurality of sensors. The controller is programmed to receive input from the plurality of sensors indicative of a seating condition of the seated occupant. The seating condition is compared to a predetermined seating condition. An output indicative of the predetermined seating condition is transmitted. An actuator is in electrical communication with the plurality of sensors and operably connected to at least one of the seat bottom and the seat back for adjustment of at least one of a plurality of settings of the seat assembly. The actuator is adjusted to a predetermined setting corresponding to the predetermined seating condition.

### TECHNICAL FIELD

Various embodiments relate to seat position detection for seat assemblies.

### BACKGROUND

Galbreath et al. U.S. Patent Application Publication US 2012/0096960 A1, which published on Apr. 26, 2012, discloses a system that generates dynamic seating body distribution data.

### SUMMARY

According to at least one embodiment, a seat assembly is provided with a seat bottom and a seat back. A plurality of sensors is operably connected to at least one of the seat bottom and the seat back to detect a seating condition. A controller is in electrical communication with the plurality of sensors. The controller is programmed to receive input from the plurality of sensors indicative of a seating condition. The seating condition is compared to a predetermined seating condition. An output indicative of the predetermined seating condition is transmitted.

According to at least another embodiment, a seat assembly is provided with a seat bottom and a seat back. At least one actuator is operably connected to at least one of the seat bottom and the seat back for adjustment of at least one of a plurality of settings of the seat assembly. A plurality of sensors is operably connected to at least one of the seat bottom and the seat back to detect a seating condition. A controller is in electrical communication with the plurality of sensors and the at least one actuator. The controller is programmed to receive input from the plurality of sensors indicative of a seating condition. The seating condition of the seated occupant is compared to a predetermined seating condition. The at least one actuator is adjusted to a predetermined setting corresponding to the predetermined seating condition.

### BRIEF DESCRIPTION OF THE DRAWINGS

FIG. 1 is a schematic view of a seating system according to an embodiment, including a vehicle seat assembly according to another embodiment;

FIG. 2 is a side elevation view of the vehicle seat assembly of FIG. 1, illustrated partially disassembled;

FIG. 3 is another side elevation view of the vehicle seat assembly of FIG. 1, illustrated partially disassembled with a schematic illustration of a range of motion in a fore-aft direction of the vehicle seat assembly;

FIG. 4 is another side elevation view of the vehicle seat assembly of FIG. 1, illustrated partially disassembled with a schematic illustration of a range of motion in a height direction of the vehicle seat assembly;

FIG. 5 is another side elevation view of the vehicle seat assembly of FIG. 1, illustrated partially disassembled with a schematic illustration of a range of motion for front tilt of the vehicle seat assembly; and

FIG. 6 is another side elevation view of the vehicle seat assembly of FIG. 1, illustrated partially disassembled with a schematic illustration of a range of motion for recliner measurement of the vehicle seat assembly.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

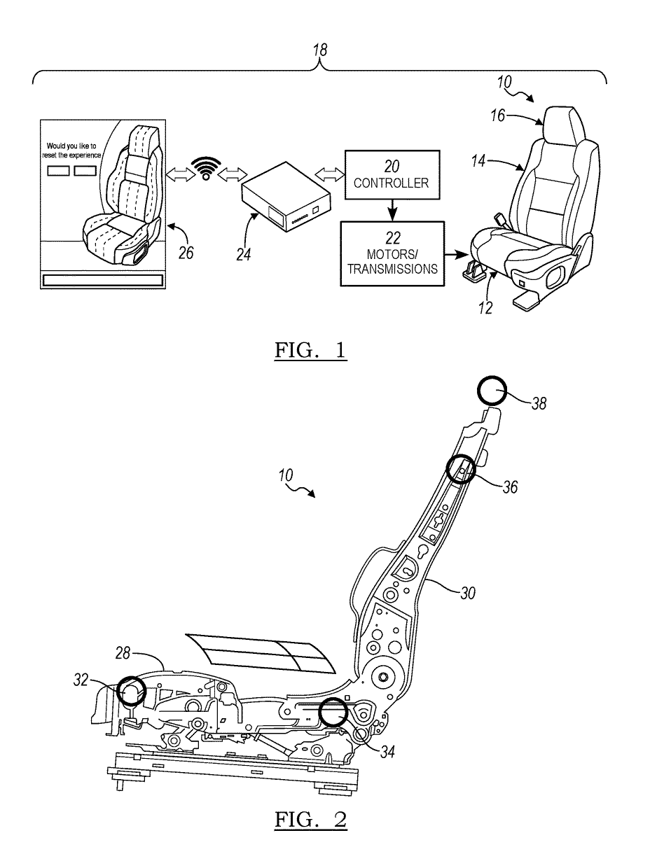

FIG. 1 illustrates a vehicle seat assembly 10 according to an embodiment. The vehicle seat assembly 10 may be employed in an automotive vehicle, an aircraft, a watercraft or the like. Alternatively, the seat assembly 10 may be employed in a non-transportation environment, such as an office chair, or the like. Moreover, the vehicle seat assembly 10 may be employed in any environment wherein it is desirable to identify the occupant.

The seat assembly 10 includes a seat bottom 12, which may be adapted to be mounted for manually adjustable translation in a fore and aft direction, in an up and down direction of a vehicle, and for tilt adjustment relative to the vehicle. According to another embodiment, these adjustments are motor-driven. The seat assembly 10 includes a seat back 14, which may be pivotally connected to the seat bottom 12 to extend generally upright relative to the seat bottom 12 for pivotal adjustment relative to the seat bottom 12. A head restraint 16 is mounted for adjustable translation to the seat back 14.

FIG. 1 also illustrates an adjustable seating system 18 according to an embodiment. The seating system 18 includes the seat assembly 10. For the motor-driven embodiment, a memory control seat module (MCSM) is provided on the seat back 14 and identified generally as a controller 20. The controller 20 controls a plurality of motors and corresponding transmissions 22 in the seat assembly 10 for adjusting the various adjustment features of the seat assembly 10. The controller 20 may be provided in a module under the seat bottom 12, and may be a multifunction controller that also controls other functions in the vehicle.

The controller 20 communicates with a gateway module 24 through a CANbus connection. The gateway module 24 may be installed in or under the seat, or anywhere in the vehicle. The gateway module 24 may also be integrated with the controller 20.

The gateway module 24 communicates with an interface 26 via a wireless communication. The interface 26 may be integrated into the vehicle, such as an instrument panel display that is in suitable wired or wireless communication with the controller 20. The interface 26 may be remote, such as a smart device including phones, tablets and the like. The interface 26 is depicted as a smart device application. The remote interface 26 may permit a user to transport settings to each vehicle, such as personal passenger vehicles, airline seating, rental cars, and the like. The smart device application is further described in Pereny et al. U.S. Patent Application Publication No. 2015/0351692 A1, filed on Dec. 4, 2014, which is incorporated in its entirety by reference herein.

FIG. 1 illustrates a display image from the interface 26. The display image of the interface 26 may depict the vehicle seat assembly 10 with various adjustment ranges of the seat assembly 10. This visualization may assist an occupant in positioning upon the seat assembly 10 with live visual feedback.

With reference now to FIG. 2, the seat assembly 10 is illustrated partially disassembled according to an embodiment, with the head restraint 16 removed. Also a cover, trim, and cushioning are removed from the seat assembly 10 in FIG. 2. The seat assembly 10 is illustrated with a seat bottom frame 28 and a seat back frame 30. The seat assembly 10 includes a plurality of pairs of sensors 32, 34, 36, 38 for detecting a seating position of the seat assembly 10. According to one embodiment, each pair of sensors 32, 34, 36, 38 may include a pair of three-axis gyroscopic and accelerometer sensors to provide measurements of at each of the pairs of sensors 32, 34, 36, 38. The sensors 32, 34, 36, 38 detect occupant seating position and movement. The sensors 32, 34, 36, 38 are in electrical communication with the gateway module 24 for conveying the detected information to the gateway module 24. For the motor-driven embodiment, the sensors 32, 34, 36, 38 are in electrical communication with the controller 20.

Proper positioning of the seat assembly 10 is employed for placing an occupant in a properly seated posture, as may be predefined by a prior saved seating position, or a predetermined position as prescribed by a health professional. Proper adjustment may be employed for both power and manual adjusting seats. Typical seat adjustment features include fore-aft horizontal adjustment, height adjustment, front cushion tilt adjustment, recline adjustment, and head restraint adjustment. The sensors 32, 34, 36, 38 are placed on the seat assembly 10 in laterally spaced apart pairs in positions to detect the movement and location of the adjustments of the seat assembly 10.

The sensors 32, 34, 36, 38 can detect location in three directions, such as fore-aft, lateral and height. The sensors 32, 34, 36, 38 can detect angular movements in the roll, pitch, and yaw directions. The adjustment features of the seat assembly 10 can be placed into positions that place the occupant in a properly seated posture. The measurements from the sensors 32, 34, 36, 38 can then be recorded in the controller 20 or gateway module 24 for different occupant anthropometric dimensions. Once the measurements are recorded, the interface 26 can show the difference between the current adjusted position of a feature and the proper adjustment position. Human Machine Interface graphical software can display upon the interface 26 occupant current adjustments of the seat assembly 10, predetermined seating adjustments, and a range of adjustment between current and predetermined seating adjustments.

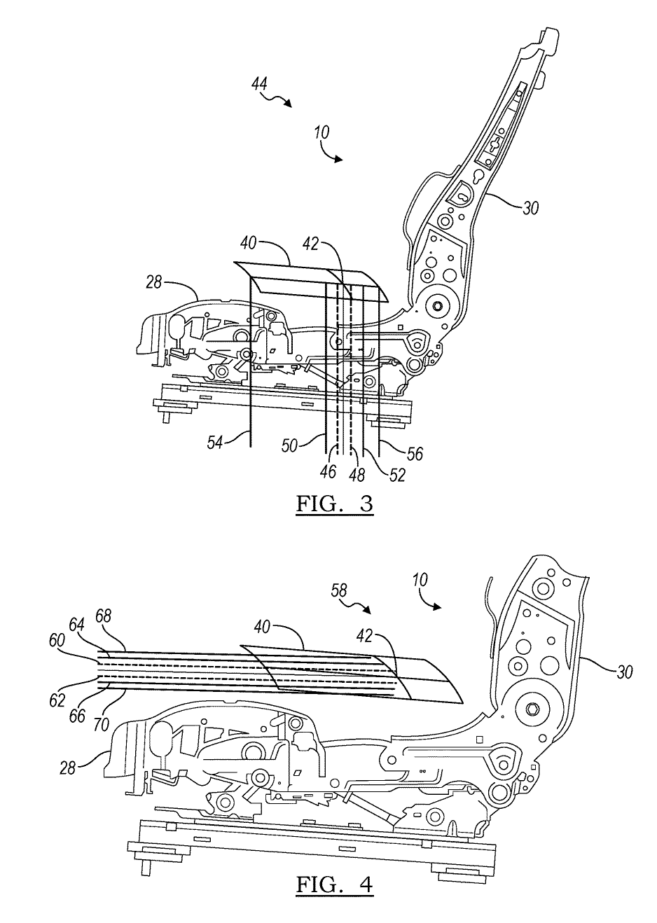

FIG. 3 illustrates the seat assembly 10 with a graphic 40 representative of a range of motion of the seat assembly 10. The graphic 40 is representative of a range of translation in the fore-aft direction and with a range of height adjustment. An intersection 42 is provided in the range graphic 40 to indicate a current location of the seat assembly 10 in the fore-aft direction and in the height direction.

For the position depicted in FIG. 3, a display image 44 is generated for assisting the occupant with seat adjustment. For example, in FIG. 3, the seat bottom sensors 32, 34 (FIG. 2) detect a seated occupant position in the fore and aft direction. The seated position is compared to a predetermined seating condition, such as a prescribed fore-aft position, or a user preference condition. The comparison is performed at the controller 20 (FIG. 1).

The controller 20 sends an image, such as the display image 44 to the interface 26. The display image 44 illustrates a target range 46-48 of linear translation in the fore-aft direction. A set of ranges, such as an intermediate range 50-46, and an intermediate range 48-52 are depicted outside the target range 46-48. Another pair of ranges range, such as an external range 54-50 and an external range 52-56 is depicted outside of the intermediate ranges 50-46, 48-52.

The location of the intersection 42 indicates whether the seat assembly 10 is in position or within target range 46-48 in the fore-aft direction. The display image 44 also indicates when the intersection 42 is close to the target range 46-48, or within one of the intermediate ranges 50-46, 48-52. The display image also indicates when the intersection 42 is out of position, when the intersection 42 is within one of the external ranges 54-50, 52-56. The display image 44 may be employed for visual guidance to the occupant, while adjusting the seat assembly 10 to the target range 46, 48. The seat bottom sensors 32, 34 periodically measure the position of the seat bottom frame 28 to update the display image 44.

According to at least one embodiment, the controller 20 (FIG. 1) employs the measurements from the sensors 32, 34 to drive a motor and transmission 22 to adjust the seat assembly 10 to the target fore-aft range 46-48. The display image 44 is employed to illustrate the movement during the adjustment.

Other adjustment features operate similar to that described with reference to fore-aft adjustment. For example, FIG. 4 illustrates the seat assembly 10 with the graphic 40 representative of translation in the fore-aft direction and with a range of height adjustment. The intersection indicates a current location of the seat assembly 10 in the fore-aft direction and in the height direction.

For the position depicted in FIG. 4, a display image 58 is generated for assisting the occupant with seat adjustment in the height direction. For example, in FIG. 4, the seat bottom sensors 32, 34 (FIG. 2) detect a seated occupant position in the height direction. The seated position is compared to a predetermined seating condition, such as a prescribed height position, or a user preference condition. The comparison is performed at the controller 20 (FIG. 1).

The controller 20 sends an image, such as the display image 58 to the interface 26. The display image 58 illustrates a target range 60-62 of translation in the height direction. Intermediate range 64-60, and intermediate range 62-66 depict ranges proximate, but outside of, the target range 60-62. External range 68-64 and external range 66-70 depict ranges that are outside of the intermediate ranges 64-60, 62-66.

The location of the intersection 42 indicates whether the seat assembly 10 is in position or within the target range 60-62 in the height direction, or close and within one of the intermediate ranges, 64-60, 62-66, or out of position within one of the external ranges 68-64, 66-70. The display image 58 may be employed for visual guidance to the occupant, while adjusting the seat assembly 10 to the target range 60-62. The seat bottom sensors 32, 34 periodically measure the position of the seat bottom frame 28 to update the display image 58. Both display images 44, 58 may be combined for concurrent adjustment of the fore-aft and height adjustments of the seat assembly 10.

According to at least one embodiment, the controller 20 (FIG. 1) employs the measurements from the sensors 32, 34 to drive a motor and transmission 22 to adjust the seat assembly 10 to the target height range 60-62. The display image 58 is employed to illustrate the movement during the adjustment.

Further adjustment features operate similar to those described with reference to fore-aft adjustment and height adjustment of FIGS. 3 and 4. By way of another example, FIG. 5 illustrates the seat assembly 10 with a graphic 72 representative of a tilt angle of the seat bottom frame 28.

For the position depicted in FIG. 5, a display image 74 is generated for assisting the occupant with seat adjustment in a range of tilt angles. For example, in FIG. 5, the seat bottom sensors 32, 34 (FIG. 2) detect a tilt angle of a seated occupant position. The seated position is compared to a predetermined seating condition, such as a prescribed tilt position, or a user preference condition. The comparison is performed at the controller 20 (FIG. 1).

The controller 20 sends an image, such as the display image 74 to the interface 26. The display image 74 illustrates a target angular range 76-78 for the tilt angle. Intermediate range 80-76, and intermediate range 78-82 depict ranges proximate, but outside of, the target range 76-78. External range 84-80 and external range 82-86 depict ranges that are outside of the intermediate ranges 80-76, 78-82.

The location of the tilt angle graphic 72 indicates whether the seat assembly 10 is in position or within the target range 76-78 for the tilt angle, or close and within one of the intermediate ranges, 80-76, 78-82, or out of position within one of the external ranges 84-80, 82-86. The display image 74 may be employed for visual guidance to the occupant, while adjusting the seat assembly 10 to the target range 76-78. The seat bottom sensors 32, 34 periodically measure the position of the seat bottom frame 28 to update the display image 74. All three display images 44, 58, 74 may be combined for concurrent adjustment of the fore-aft, height and tilt adjustments of the seat assembly 10.

According to at least one embodiment, the controller 20 (FIG. 1) employs the measurements from the sensors 32, 34 to drive a motor and transmission 22 to adjust the seat assembly 10 to the target tilt range 76-78. The display image 74 is employed to illustrate the movement during the adjustment.

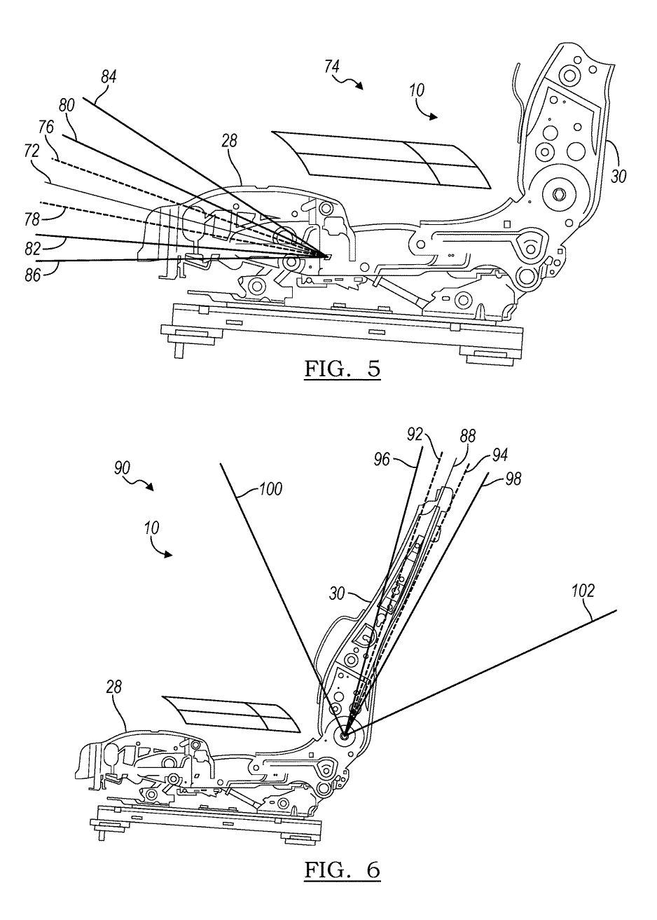

Further adjustment features operate similar to those described with reference to fore-aft adjustment, height adjustment and tilt adjustment of FIGS. 3-5. By way of another example, FIG. 6 illustrates the seat assembly 10 with a graphic 88 representative of a recline angle of the seat back frame 30.

For the position depicted in FIG. 6, a display image 90 is generated for assisting the occupant with seat adjustment in a range of recline angles. For example, in FIG. 6, the seat back sensors 36, 38 (FIG. 2) detect a recline angle of a seated occupant position. The seated position is compared to a predetermined seating condition, such as a prescribed recline position, or a user preference condition. The comparison is performed at the controller 20 (FIG. 1).

The controller 20 sends an image, such as the display image 90 to the interface 26. The display image 90 illustrates a target angular range 92-94 for the recline angle. Intermediate range 96-92, and intermediate range 94-98 depict ranges proximate, but outside of, the target range 92-94. External range 100-96 and external range 98-102 depict ranges that are outside of the intermediate ranges 96-92, 94-98.

The location of the recline angle graphic 88 indicates whether the seat assembly 10 is in position or within the target range 92-94 for the recline angle, or close and within one of the intermediate ranges, 96-92, 94-98, or out of position within one of the external ranges 100-96, 98-102. The display image 90 may be employed for visual guidance to the occupant, while adjusting the seat assembly 10 to the target range 92-94. The seat back sensors 36, 38 periodically measure the position of the seat back frame 30 to update the display image 90. All four display images 44, 58, 74, 90 may be employed in any combination for concurrent adjustment of the fore-aft, height, tilt and recline adjustments of the seat assembly 10.

According to at least one embodiment, the controller 20 (FIG. 1) employs the measurements from the sensors 36, 38 to drive a motor and transmission 22 to adjust the seat assembly 10 to the target recline range 92-94. The display image 90 is employed to illustrate the movement during the adjustment.

While various embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

1. A seat assembly comprising:
a seat bottom;
a seat back;
wherein a position of at least one of the seat bottom and the seat back is manually adjustable;
a plurality of sensors operably connected to at least one of the seat bottom and the seat back to detect a seating condition and to detect manual adjustment to the seating position; and
a controller in electrical communication with the plurality of sensors, the controller being programmed to:
receive input from the plurality of sensors indicative of the seating condition,
compare the seating condition to a predetermined seating condition, and
transmit an output indicative of the predetermined seating condition.

2. The seat assembly of claim 1 wherein the input indicative of the seating condition comprises input indicative of a fore-aft position of the seat bottom.

3. The seat assembly of claim 2 wherein the input indicative of the seating condition further comprises:
input indicative of a height position of the seat bottom;
input indicative of a tilt position of the seat bottom; and
indicative of a recline position of the seat back.

4. The seat assembly of claim 1 wherein the input indicative of the seating condition comprises input indicative of a height position of the seat bottom.

5. The seat assembly of claim 1 wherein the input indicative of the seating condition comprises input indicative of a tilt position of the seat bottom.

6. The seat assembly of claim 1 wherein the input indicative of the seating condition comprises input indicative of a recline position of the seat back.

7. The seat assembly of claim 1 wherein the plurality of sensors comprise a plurality of gyroscopic sensors.

8. The seat assembly of claim 1 wherein the plurality of sensors comprise a plurality of six-axis sensors.

9. The seat assembly of claim 1 wherein the plurality of sensors comprise an array of four sensors.

10. The seat assembly of claim 1 further comprising a display in communication with the controller to display an image of the predetermined seating condition.

11. The seat assembly of claim 1 wherein the controller is further programmed to transmit an output indicative of the seating condition.

12. The seat assembly of claim 11 further comprising a display in communication with the controller to display an image of the seating condition and the predetermined seating condition.

13. The seat assembly of claim 11 wherein the controller is further programmed to transmit an output indicative of at least one adjustment from the seating condition to the predetermined seating condition.

14. The seat assembly of claim 13 further comprising a display in communication with the controller to display an image of the seating condition, the predetermined seating condition and the at least one adjustment.

15-20. (canceled)
